(19) United States
(12) Patent Application Publication
(10) Pub. No.: US 2024/0072336 A1
(43) Pub. Date: Feb. 29, 2024

(54) BATTERY THERMAL BARRIER AND VENTING SYSTEMS

(71) Applicant: FORD GLOBAL TECHNOLOGIES, LLC, Dearborn, MI (US)

(72) Inventors: Bhaskara Rao Boddakayala, Troy, MI (US); Stefan Paul Pototschnik, Canton, MI (US)

(21) Appl. No.: 17/897,459

(22) Filed: Aug. 29, 2022

(51) Int. Cl. H01M 10/658; H01M 10/613; H01M 10/625; H01M 50/293; H01M 50/30

(52) U.S. Cl. CPC H01M 10/658; H01M 10/613; H01M 10/625; H01M 50/293; H01M 50/30; H01M 2220/20

(57) ABSTRACT

Battery thermal barrier and venting systems are provided for battery arrays. Exemplary battery thermal barrier and venting systems may include one or more endothermic intumescent aerogel sheets that are configured to activate when surrounding battery temperatures exceed a predefined temperature threshold, thereby mitigating cell-to-cell thermal propagation. The endothermic intumescent aerogel sheets may be incorporated as part of thermal barrier structures that are positioned between neighboring battery cells of a cell bank, as part of partition structures that are positioned between adjacent cell banks of a battery array, or both. The battery thermal barrier and venting systems may further include one or more vent ports and vent port covers for venting gases and other effluents from the battery array.

### TECHNICAL FIELD

This disclosure relates generally to electrified vehicle traction battery packs, and more particularly to thermal barrier and venting systems for managing cell-to-cell propagation during battery thermal events.

### BACKGROUND

Electrified vehicles are designed to reduce or completely eliminate reliance on internal combustion engines. In general, electrified vehicles differ from conventional motor vehicles because they are selectively driven by battery powered electric machines. Conventional motor vehicles, by contrast, rely exclusively on the internal combustion engine to propel the vehicle.

A high voltage traction battery pack typically powers the electric machines and other electrical loads of the electrified vehicle. The traction battery pack includes a plurality of battery cells and various other battery internal components that support the electric propulsion of electrified vehicles.

### SUMMARY

A battery thermal barrier and venting system according to an exemplary aspect of the present disclosure includes, among other things, a cell stack, and an endothermic intumescent aerogel sheet integrated as part of the cell stack. The endothermic intumescent aerogel sheet is configured to absorb heat and expand to limit cell-to-cell propagation across the cell stack when a temperature surrounding the cell stack exceeds a predefined temperature threshold.

In a further non-limiting embodiment of the forgoing battery thermal barrier and venting system, the cell stack includes a plurality of battery cells that are electrically connected in parallel.

In a further non-limiting embodiment of either of the foregoing battery thermal barrier and venting systems, the endothermic intumescent aerogel sheet is part of a multi-layered structure.

In a further non-limiting embodiment of any of the foregoing battery thermal barrier and venting systems, the multi-layered structure is a thermal barrier structure that includes the endothermic intumescent aerogel sheet sandwiched between a first foam plate and a second foam plate.

In a further non-limiting embodiment of any of the foregoing battery thermal barrier and venting systems, the multi-layered structure is a partition structure that includes a foam plate, the endothermic intumescent aerogel sheet, and a metallic wrapped aerogel cushion.

In a further non-limiting embodiment of any of the foregoing battery thermal barrier and venting systems, the metallic wrapped aerogel cushion includes an insulating cushion wrapped in a metallic wrapping comprising aluminum, stainless steel, or tin.

In a further non-limiting embodiment of any of the foregoing battery thermal barrier and venting systems, the partition structure divides the cell stack into a first cell bank and a second cell bank.

In a further non-limiting embodiment of any of the foregoing battery thermal barrier and venting systems, the cell stack is surrounded by a support structure that includes a top plate, and a seal extends between the top plate and the partition structure to divide an interior of the support structure into a first portion and a second portion.

In a further non-limiting embodiment of any of the foregoing battery thermal barrier and venting systems, the first cell bank is located in the first portion, and the second cell bank is located in the second portion.

In a further non-limiting embodiment of any of the foregoing battery thermal barrier and venting systems, the cell stack is surrounded by a support structure, and a vent port opens through the support structure.

In a further non-limiting embodiment of any of the foregoing battery thermal barrier and venting systems, a vent port cover is positioned over the vent port.

In a further non-limiting embodiment of any of the foregoing battery thermal barrier and venting systems, the endothermic intumescent aerogel sheet includes a non-woven ceramic fiber that includes an integrated intumescent filler.

A battery thermal barrier and venting system according to another exemplary aspect of the present disclosure includes, among other things, a battery array including a cell stack and a support structure that at least partially surrounds the cell stack. The cell stack includes a first cell bank and a second cell bank. A partition assembly is arranged to isolate the first cell bank from the second cell bank. The partition assembly includes a first endothermic intumescent aerogel sheet.

In a further non-limiting embodiment of the foregoing battery thermal barrier and venting system, the first intumescent aerogel sheet is part of a partition structure of the partition assembly. The partition structure is positioned axially between the first cell bank and the second cell bank.

In a further non-limiting embodiment of either of the foregoing battery thermal barrier and venting systems, the partition structure includes a first foam panel, a second foam panel, the first endothermic intumescent aerogel sheet, a second endothermic intumescent aerogel sheet, and a metallic wrapped aerogel cushion.

In a further non-limiting embodiment of any of the foregoing battery thermal barrier and venting systems, the partition assembly includes a seal that is arranged to extend between a top plate of the support structure and an upper portion of the partition structure.

In a further non-limiting embodiment of any of the foregoing battery thermal barrier and venting systems, a thermal barrier structure is positioned within the first cell bank or the second cell bank.

In a further non-limiting embodiment of any of the foregoing battery thermal barrier and venting systems, the thermal barrier structure includes a second endothermic intumescent aerogel sheet.

In a further non-limiting embodiment of any of the foregoing battery thermal barrier and venting systems, a thermal barrier structure is positioned between the cell stack and the support structure.

In a further non-limiting embodiment of any of the foregoing battery thermal barrier and venting systems, the thermal barrier structure includes a second endothermic intumescent aerogel sheet.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates a powertrain of an electrified vehicle.

FIG. 2 illustrates an exemplary thermal barrier and venting system for a battery array of a traction battery pack.

FIG. 3 illustrates features associated with a vent port cover of the thermal barrier and venting system of FIG. 2.

### DETAILED DESCRIPTION

This disclosure details exemplary battery thermal barrier and venting systems for battery arrays. Exemplary battery thermal barrier and venting systems may include one or more endothermic intumescent aerogel sheets that are configured to activate when surrounding battery temperatures exceed a predefined temperature threshold, thereby mitigating cell-to-cell thermal propagation. The endothermic intumescent aerogel sheets may be incorporated as part of thermal barrier structures that are positioned between neighboring battery cells of a cell bank, as part of partition structures that are positioned between adjacent cell banks of a battery array, or both. The battery thermal barrier and venting systems may further include one or more vent ports and vent port covers for venting gases and other effluents from the battery array. These and other features are discussed in greater detail in the following paragraphs of this detailed description.

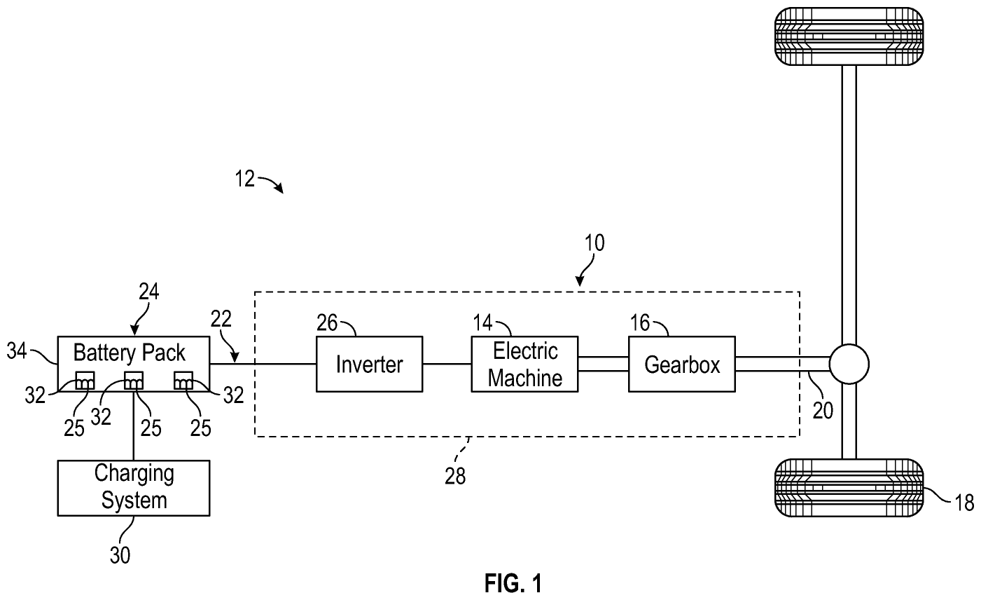

FIG. 1 schematically illustrates a powertrain 10 of an electrified vehicle 12. In an embodiment, the electrified vehicle 12 is a battery electric vehicle (BEV). However, it should be understood that the concepts described herein are not limited to BEVs and could extend to other electrified vehicles, including, but not limited to, hybrid electric vehicles (HEVs), plug-in hybrid electric vehicles (PHEVs), fuel cell vehicles, etc. Although not shown in this exemplary embodiment, the electrified vehicle 12 could be equipped with an internal combustion engine that can be employed either alone or in combination with other energy sources to propel the electrified vehicle 12.

In the illustrated embodiment, the electrified vehicle 12 is a full electric vehicle propelled solely through electric power, such as by an electric machine 14, without any assistance from an internal combustion engine. The electric machine 14 may operate as an electric motor, an electric generator, or both. The electric machine 14 receives electrical power and provides a rotational output torque. The electric machine 14 may be connected to a gearbox 16 for adjusting the output torque and speed of the electric machine 14 by a predetermined gear ratio. The gearbox 16 may be operably connected to a set of drive wheels 18 by an output shaft 20.

A voltage bus 22 electrically connects the electric machine 14 to a traction battery pack 24 through an inverter 26, which can also be referred to as an inverter system controller (ISC). The electric machine 14, the gearbox 16, and the inverter 26 may be collectively referred to as a transmission 28 of the electrified vehicle 12.

The traction battery pack 24 is an exemplary electrified vehicle battery. The traction battery pack 24 may be a high voltage traction battery pack that includes one or more battery arrays 25 (i.e., battery assemblies, battery modules, or groupings of battery cells) capable of outputting electrical power to operate the electric machine 14 and/or other electrical loads of the electrified vehicle 12. Other types of energy storage devices and/or output devices can also be used to electrically power the electrified vehicle 12.

The one or more battery arrays 25 of the traction battery pack 24 may each include a plurality of battery cells 32 that store energy for powering various electrical loads of the electrified vehicle 12. The traction battery pack 24 could employ any number of battery cells 32 within the scope of this disclosure. Accordingly, this disclosure should not be limited to the specific configuration shown in FIG. 1.

In an embodiment, the battery cells 32 are lithium-ion cells. However, other cell chemistries (nickel-metal hydride, lithium-iron phosphate, etc.) could alternatively be utilized within the scope of this disclosure.

In another embodiment, the battery cells 32 are prismatic or pouch battery cells. However, other cell geometries could alternatively be utilized within the scope of this disclosure.

An enclosure assembly 34 may house the battery arrays 25 of the traction battery pack 24. In an embodiment, the enclosure assembly 34 is a sealed outer enclosure that establishes the outermost surfaces of the traction battery pack 24. The enclosure assembly 34 may include any size, shape, and configuration within the scope of this disclosure. The battery arrays 25 and other battery internal components of the traction battery pack 24 are separate structures from the enclosure assembly 34 and therefore are not considered to established any portion of the outermost surfaces of the traction battery pack 24.

The electrified vehicle 12 may further include a charging system 30 for charging the energy storage devices (e.g., the battery cells 32) of the traction battery pack 24. The charging system 30 may include charging components that are located both onboard the electrified vehicle 12 (e.g., a vehicle charge port assembly, etc.) and external to the electrified vehicle 12 (e.g., electric vehicle supply equipment (EVSE), etc.). The charging system 30 can be connected to an external power source (e.g., a grid power source) for receiving and distributing power received from the external power source throughout the electrified vehicle 12.

The powertrain 10 depicted by FIG. 1 is highly schematic and is not intended to limit this disclosure. Various additional components could alternatively or additionally be employed by the powertrain 10 within the scope of this disclosure.

During operation of the electrified vehicle 12, the battery cells 32 and other internal components of the traction battery pack 24 can experience a relatively rare event known as thermal runaway during certain battery thermal events (e.g., overcharging, overdischarging, overheating, short circuit events, etc.). Further, during such conditions, the battery cells 32 may vent gases and/or other effluents into the interior of the enclosure assembly 34. The vent gases may be caused by an applied force or a thermal event, and can either cause or exacerbate an existing battery thermal event. A relatively significant amount of heat can be generated during battery thermal events, and if not contained, the generated heat can cascade to other battery internal components, thereby hastening thermal runaway within the traction battery pack 24. This disclosure is therefore directed to battery array designs that incorporate thermal barrier and venting systems for mitigating cell-to-cell thermal propagation within the battery arrays 25 during certain battery thermal events.

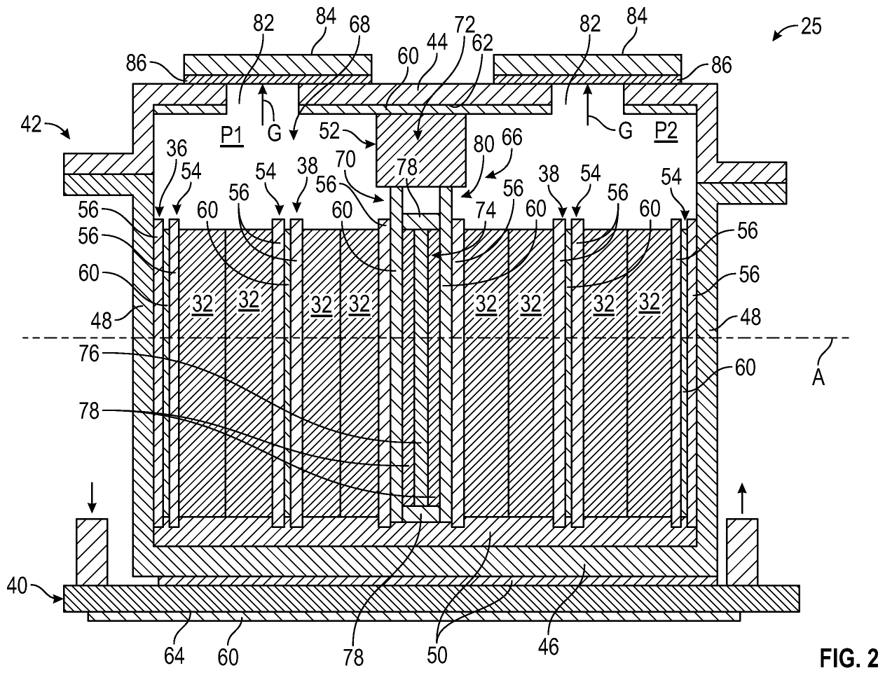

FIG. 2 illustrates an exemplary battery array 25 for a traction battery pack, such as the traction battery pack 24 of FIG. 1, for example. As explained in further detail below, the battery array 25 may incorporate thermal barrier and venting features designed for mitigating or even preventing cell-to-cell thermal propagation during battery thermal events.

The battery array 25 may include a plurality of battery cells 32. The total number of battery cells 32 provided within the battery array 25 may vary and is not intended to limit this disclosure. The battery cells 32 may be grouped together in a cell stack 36, which itself may include two or more cell banks 38. In the illustrated embodiment, each cell bank 38 includes a total of four battery cells 32 that are electrically connected in parallel to one another. However, the cell banks 38, and thus the cell stack 36, could include any number of battery cells within the scope of this disclosure. Moreover, in some embodiments, the battery cells 32 of the cell stack 36 could be electrically connected in series.

A support structure 42 of the battery array 25 may be arranged to substantially surround the cell stack 36. In an embodiment, the support structure 42 completely encloses the cell stack 36 and includes a top plate 44, a bottom plate 46, a pair of end plates 48, and a pair of side plates (not shown in the cross-sectional side view of FIG. 2). One or more of the top plate 44, the bottom plate 46, the end plates 48, and the side plates may be integrated as part of a unitary structure. In the illustrated embodiment, the bottom plate 46 and the end plates 48 are integrated together as part of an integrated unitary array structure that interfaces with the top plate 44. However, other configurations of the support structure 42 are also possible within the scope of this disclosure.

The bottom plate 46 of the support structure 42 may be arranged to interface with a heat exchanger plate 40 (e.g., a liquid cooled cold plate). A coolant, such as water mixed with ethylene glycol or any other suitable coolant, may be circulated through an interior cooling circuit of the heat exchanger plate 40. The coolant may pick up heat that is generated within the battery cells 32 as it circulates through the internal cooling circuit of the heat exchanger plate 40.

A thermal interface material 50 (e.g., epoxy resin, silicone based materials, thermal greases, etc.) may be disposed between the battery cells 32 of the cell stack 36 and the bottom plate 46 of the support structure 42 for facilitating heat transfer therebetween. The thermal interface material 50 may further be disposed between the bottom plate 46 of the support structure 42 and the heat exchanger plate 40.

The battery array 25 may further include a thermal barrier and venting system 52 (hereinafter referred to simply as “the system 52”) for mitigating the thermal runaway effects and the resulting cell-to-cell propagation that can occur during battery thermal events. For example, among other benefits, the system 52 may be configured to prolong the amount of time it takes for electrical energy to transfer from cell-to-cell within the cell stack 36 during battery thermal events. The system 52 may be further configured to vent gases G and/or other effluents to a location outside of the battery array 25 (e.g., external to the support structure 42 of the battery array 25) during the battery thermal events.

The system 52 may include a plurality of thermal barrier structures 54 that are incorporated into the cell stack 36. The thermal barrier structures 54 may be positioned at various locations along the length of the cell stack 36 and are adapted for slowing cell-to-cell propagation during battery thermal events. In an embodiment, one thermal barrier structure 54 may be positioned between the cell stack 36 and each end plate 48 of the support structure 42. Further, each cell bank 38 of the cell stack 36 may include at least one thermal barrier structure 54 positioned therein, with the thermal barrier structure 54 being positioned between adjacent battery cells 32 of the cell bank 38. In an embodiment, one thermal barrier structure 54 is disposed at the mid-point of each cell bank 38. However, other configurations are also contemplated, and therefore the total number of thermal barrier structures 54 provided as part of the cell stack 36 is not intended to limit this disclosure.

Each thermal barrier structure 54 of the system 52 may include a multi-layered structure, with each layer of the structure having a unique function associated with mitigating thermal propagation during battery thermal events. The thermal barrier structure 54 may include a pair of foam plates 56 and an endothermic intumescent aerogel sheet 60 sandwiched between the foam plates 56. Notably, the various sheets/layers of the thermal barrier structure 54 are not drawn to scale, and in the interests of simplicity and clarity, are shown in a highly schematic manner in FIG. 2.

In an embodiment, the foam sheets 56 of each thermal barrier structure 54 are configured as polyurethane foam sheets. However, the foam sheets 56 could be constructed from other materials or combinations of materials within the scope of this disclosure.

The foam plates 56 may be configured to absorb stress loads exerted by the cell stack 36, such as during expansion and contraction of the battery cells 32, for example. The foam plates 56 may thus reduce the loads acting on the end plates 48 of the support structure 42 throughout the operable life of the battery array 25. Further, during battery thermal events, the foam plates 56 may be designed to melt or otherwise destruct when the temperature inside the battery array 25 exceeds a predefined temperature threshold (e.g., between about 120° C. and about 200° C.), thereby permitting the endothermic intumescent aerogel sheet 60 to perform its inherent heat absorption and expansion functions. In this disclosure, the term “about” means that the expressed quantities or ranges need not be exact but may be approximated and/or larger or smaller, reflecting acceptable tolerances, conversion factors, measurement error, etc.

In an embodiment, the endothermic intumescent aerogel sheet 60 is a non-woven ceramic fiber that includes integrated fillers (e.g., aluminum trihydrate, sodium silicate, etc.) for providing the endothermic and intumescent qualities. However, the endothermic intumescent aerogel sheet 60 could be constructed from other materials or combinations of materials within the scope of this disclosure.

The endothermic intumescent aerogel sheet 60 may be configured to both absorb heat and expand during some battery thermal events. For example, when the temperature inside the battery array 25 exceeds a predefined temperature threshold (e.g., between about 120° C. and about 200° C.), the endothermic intumescent aerogel sheet 60 may expand and take the place of the melted foam plates 58, 60, thereby maintaining the structural integrity of the cell stack 36. The expanding endothermic intumescent aerogel sheets 60 may further absorb heat energy from the battery cells 32 during the battery thermal event by containing at least portions of the convective effects of the gasses G, thereby minimizing their effect on neighboring battery cells 32 and reducing the overall temperature within the battery array 25. The expansion of the endothermic intumescent aerogel sheets 60 generally only occurs at areas of the battery array 25 where there is no active cell material. Therefore, expansion of the endothermic intumescent aerogel sheet 60 will not negatively influence neighboring battery cells 32.

By providing the thermal barrier structure 54 between neighboring battery cells 32 that are electrically connected in parallel within each cell bank 38 of the cell stack, the amount of time required for electrical energy to be transferred to the battery cell(s) 32 experiencing the thermal runaway can be prolonged. As a result, the next battery cell 32 in the parallel configuration will enter into thermal runaway at a lower state of charge. However, the thermal barrier structures 54 may also be beneficially used when the battery cells 32 are connected in series.

Moreover, positioning the thermal barrier structure 54 near the mid-point of each cell bank 38 prolongs the amount of time it takes for heat to transfer through the thermally conductive connections, thereby prolonging propagation time and/or arresting thermal propagation to a minimum number of battery cells 32 of the cell stack 36.

On or more endothermic intumescent aerogel sheets 60 may additionally be attached to both the top plate 44 of the support structure 42 and the heat exchanger plate 40. For example, one endothermic intumescent aerogel sheet 60 may be attached to an inner surface 62 of the top plate 44, and another endothermic intumescent aerogel sheet 60 may be attached to an exterior surface 64 of the heat exchanger plate 40. The exterior surface 64 is located on an opposite side of the heat exchanger plate 40 from the thermal interface material 50. Each of these additional endothermic intumescent aerogel sheets 60 may be designed to absorb heat and expand during battery thermal events, thereby reducing the amount of heat that can be transferred back to the cell stack 36 for further mitigating cell-to-cell propagation.

The system 52 may further include one or more partition assemblies 66. In the illustrated embodiment, the partition assembly 66 is positioned axially between the pair of neighboring cell banks 38 of the cell stack 36 of the battery array 25. The partition assembly 66 may further interface with the top plate 44 (or the sheet 60 connected to the top plate 44) of the support structure 42. As further discussed below, the partition assembly 66 may isolate a first portion P1 of an interior 68 of the battery array 25 where a first of the cell banks 38 resides from a second portion P2 of the interior 68 where a neighboring cell bank 38 resides.

The partition assembly 66 may include a partition structure 70 and a seal 72. The partition structure 70 may be positioned axially between the pair of cell banks 38 of the cell stack 36. Like the thermal barrier structures 54 discussed above, the partition structure 70 may include a multi-layered structure, with each layer of the structure having a unique function associated with mitigating cell-to-cell thermal propagation during battery thermal events. The partition structure 70 may include a pair of foam plates 56, a pair of endothermic intumescent aerogel sheets 60, and a metallic wrapped aerogel cushion 74. Notably, the various sheets/layers of the partition structure 70 are not drawn to scale, and in the interests of simplicity and clarity, are shown in a highly schematic manner in FIG. 2.

One of the foam plates 56 may interface with one of the cell banks 38, and the other foam plate 58 may interface with the neighboring cell bank 38. In an embodiment, the endothermic intumescent aerogel sheets 60 may be positioned to flank the metallic wrapped aerogel cushion 74, and the foam plates 56 may be positioned to flank the endothermic intumescent aerogel sheets 60 to establish the multi-layered sandwich structure of the partition structure 70.

The foam plates 56 and the endothermic intumescent aerogel sheets 60 are configured to be similar to the same respective parts described above with reference to the thermal barrier structures 54. Therefore, the respective design and function of these layers are not repeated here.

In an embodiment, the metallic wrapped aerogel cushion 74 may include a cushion 76 that is wrapped in a metallic wrapping 78. The cushion 76 may be a ceramic fiber or aerogel cushion, and the metallic wrapping 78 may include either aluminum, stainless steel, or tin. However, the metallic wrapped aerogel cushion 74 could be constructed from other materials or combinations of materials within the scope of this disclosure.

The metallic wrapping 78 of the metallic wrapped aerogel cushion 74 may be configured to act as a heat spreader for conducting heat from the battery cells 32 in a direction that is transverse to a longitudinal axis A of the cell stack 36. Moreover, the cushion 76 of the metallic wrapped aerogel cushion 74 may be configured to act as an insulating layer for minimizing heat transfer from cell bank 38-to-cell bank 38 and from one of endothermic intumescent aerogel sheets 60 to the other intumescent aerogel sheets 60 during battery thermal events.

The seal 72 of the partition assembly 66 may be configured to seal the interface between the partition structure 70 and the top plate 44 of the support structure 42. Thus, the partition structure 70 and the seal 72 may function to divide the interior 68 into the first portion P1 and the second portion P2. The seal 72 may be arranged to extend between the inner surface 62 of the top plate 44 and an upper portion 80 of the partition structure 70. The seal 72 may include a high temperature aerogel/silicate filled foam, a gasket-type seal, or any other suitable seal structure.

The system 52 may further include a plurality of vent ports 82 for expelling the gases G or other effluents from the battery array 25 during battery thermal events. The vent ports 82 may be openings formed through the top plate 44 of the support structure 42. In an embodiment, a first portion of the vent ports 82 may be in fluid communication with the first portion P1 of the interior 68 of the battery array 25, and a second portion of the vent ports 82 may be in fluid communication with the second portion P2 of the interior 68. Therefore, the gases G may be expelled from the battery array 25 irrespective of which cell bank 38 the thermal runaway event originates from and without transferring heat to the neighboring cell bank(s) 38.

The vent ports 82 may be covered by a vent port cover 84. Each vent port cover 84 may be secured to the top plate 44 by a section of double sided adhesive tape 86. The vent port covers 84 may be porous enough to allow the gases G to pass therethrough during battery venting events. The vent port covers 84 may be made of a ceramic paper, a mica sheet, glass mat thermoplastic composites, etc.

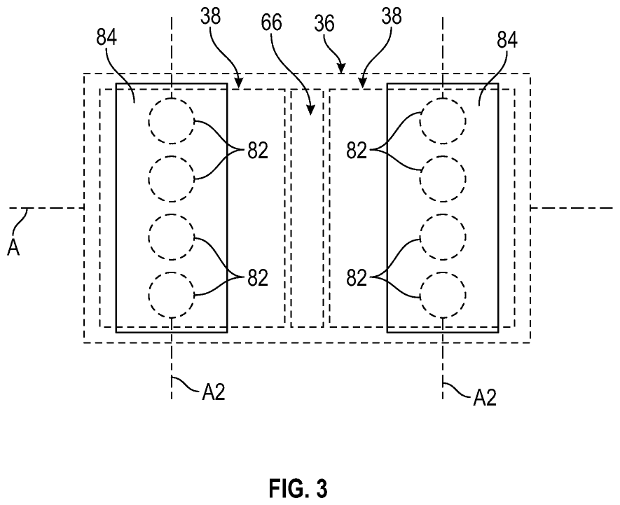

Referring now to the top view of FIG. 3, each vent port cover 84 may be arranged to cover multiple vent ports 82. The vent port covers 84 may extend along a longitudinal axis A2 that is transverse (e.g., perpendicular) to the longitudinal axis A of the cell stack 36. Stated another way, the vent port covers 84 may be positioned to extend in parallel with the length of the major faces of the battery cells 32. This type of venting configuration can help minimize the amount of energy that can be transferred cell-to-cell along the length of the cell stack 36 during battery thermal events.

The vent ports 82 are shown in an exemplary configuration in FIG. 3. However, various other configurations, including staggered configurations, could also be implemented. The size, shape, placement, and orientation of the vent ports 82 and the vent port covers 84 are not intended to limit this disclosure.

The exemplary battery thermal barrier and venting systems of this disclosure are designed to mitigate or even prevent thermal runaway inside electrified vehicle traction battery arrays/packs. The systems may provide numerous advantages over known solutions, including but not limited to presenting a novel configuration that significantly slows or even prevents cell-to-cell propagation at a minimum energy content.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A battery thermal barrier and venting system, comprising:
a cell stack; and
an endothermic intumescent aerogel sheet integrated as part of the cell stack,
wherein the endothermic intumescent aerogel sheet is configured to absorb heat and expand to limit cell-to-cell propagation across the cell stack when a temperature surrounding the cell stack exceeds a predefined temperature threshold.

2. The battery thermal barrier and venting system as recited in claim 1, wherein the cell stack includes a plurality of battery cells that are electrically connected in parallel or series.

3. The battery thermal barrier and venting system as recited in claim 1, wherein the endothermic intumescent aerogel sheet is part of a multi-layered structure.

4. The battery thermal barrier and venting system as recited in claim 3, wherein the multi-layered structure is a thermal barrier structure that includes the endothermic intumescent aerogel sheet sandwiched between a first foam plate and a second foam plate.

5. The battery thermal barrier and venting system as recited in claim 3, wherein the multi-layered structure is a partition structure that includes a foam plate, the endothermic intumescent aerogel sheet, and a metallic wrapped aerogel cushion.

6. The battery thermal barrier and venting system as recited in claim 5, wherein the metallic wrapped aerogel cushion includes an insulating cushion wrapped in a metallic wrapping comprising aluminum, stainless steel, or tin.

7. The battery thermal barrier and venting system as recited in claim 5, wherein the partition structure divides the cell stack into a first cell bank and a second cell bank.

8. The battery thermal barrier and venting system as recited in claim 7, wherein the cell stack is surrounded by a support structure that includes a top plate, and further wherein a seal extends between the top plate and the partition structure to divide an interior of the support structure into a first portion and a second portion.

9. The battery thermal barrier and venting system as recited in claim 8, wherein the first cell bank is located in the first portion, and the second cell bank is located in the second portion.

10. The battery thermal barrier and venting system as recited in claim 1, wherein the cell stack is surrounded by a support structure, and further comprising a vent port opening through the support structure.

11. The battery thermal barrier and venting system as recited in claim 10, comprising a vent port cover positioned over the vent port.

12. The battery thermal barrier and venting system as recited in claim 1, wherein the endothermic intumescent aerogel sheet includes a non-woven ceramic fiber that includes an integrated intumescent filler.

13. A battery thermal barrier and venting system, comprising:
a battery array including a cell stack and a support structure that at least partially surrounds the cell stack,
wherein the cell stack includes a first cell bank and a second cell bank; and
a partition assembly arranged to isolate the first cell bank from the second cell bank,
wherein the partition assembly includes a first endothermic intumescent aerogel sheet.

14. The battery thermal barrier and venting system as recited in claim 13, wherein the first intumescent aerogel sheet is part of a partition structure of the partition assembly, and further wherein the partition structure is positioned axially between the first cell bank and the second cell bank.

15. The battery thermal barrier and venting system as recited in claim 14, wherein the partition structure includes a first foam panel, a second foam panel, the first endothermic intumescent aerogel sheet, a second endothermic intumescent aerogel sheet, and a metallic wrapped aerogel cushion.

16. The battery thermal barrier and venting system as recited in claim 14, wherein the partition assembly includes a seal that is arranged to extend between a top plate of the support structure and an upper portion of the partition structure.

17. The battery thermal barrier and venting system as recited in claim 13, comprising a thermal barrier structure positioned within the first cell bank or the second cell bank.

18. The battery thermal barrier and venting system as recited in claim 17, wherein the thermal barrier structure includes a second endothermic intumescent aerogel sheet.

19. The battery thermal barrier and venting system as recited in claim 13, comprising a thermal barrier structure positioned between the cell stack and the support structure.

20. The battery thermal barrier and venting system as recited in claim 19, wherein the thermal barrier structure includes a second endothermic intumescent aerogel sheet.
